(19) United States
(12) Patent Application Publication
(10) Pub. No.: US 2026/0065027 A1
(43) Pub. Date: Mar. 5, 2026

(54) PERFORMANCE PREDICTION METHOD, STORAGE MEDIUM AND APPARATUS

(71) Applicant: KABUSHIKI KAISHA TOSHIBA, Tokyo (JP)

(72) Inventors: Naoki Chiba, Yokohama Kanagawa (JP); Yuki Furutani, Hiratsuka Kanagawa (JP)

(21) Appl. No.: 19/276,592

(22) Filed: Jul. 22, 2025

(30) Foreign Application Priority Data
Sep. 3, 2024 (JP) 2024-151334

(51) Int. Cl. G06N 3/0464; G06N 3/08

(52) U.S. Cl. CPC G06N 3/0464; G06N 3/08

(57) ABSTRACT

According to one embodiment, a performance prediction method includes a conversion process, a training process, and a prediction process. The conversion process converts one-dimensional array data including a plurality of parameter values arranged in one dimension into two-dimensional array data. The training process trains a machine learning model based on training data, and generates a trained model that takes two-dimensional array data as input and provides predicted performance data as output. The prediction process applies two-dimensional array data of a processing target to the trained model to generate predicted performance data for the processing target.

### CROSS-REFERENCE TO RELATED APPLICATIONS

This application is based upon and claims the benefit of priority from Japanese Patent Application No. 2024-151334, filed Sep. 3, 2024, the entire contents of which are incorporated herein by reference.

### FIELD

Embodiments described herein relate generally to a performance prediction method, storage medium and apparatus.

### BACKGROUND

A neural network model exists that predicts blower performance, such as airflow, static pressure, and efficiency, from blade geometry parameters including blade dimensions. Since the blade geometry parameters are input to the neural network as input data in a one-dimensional array, the neural network may not be able to learn the local correlations between the blade geometry parameters. Thus, there is still room for improvement in the accuracy of performance prediction.

### BRIEF DESCRIPTION OF THE DRAWING

FIG. 1 is a diagram illustrating the hardware configuration of a performance prediction apparatus.

FIG. 2 is a diagram illustrating the processing procedure of a performance prediction process.

FIG. 3 is a diagram schematically illustrating conversion from one-dimensional array parameter values to two-dimensional array data.

FIG. 4 is a diagram illustrating the network configuration of a CNN model.

FIG. 5 is a diagram illustrating the processing procedure for conversion from one-dimensional array data to two-dimensional array data.

FIG. 6 is a diagram schematically illustrating a specific example of the processing procedure shown in FIG. 5.

FIG. 7 is a diagram schematically illustrating the process for comparing the prediction accuracy of performance data between a CNN model and a DNN model.

FIG. 8 is a diagram illustrating an overview of training of a DNN model according to Example 1.

FIG. 9 is a diagram illustrating an overview of training of a CNN model according to Example 1.

FIG. 10 is a diagram illustrating the prediction accuracy of the DNN model according to Example 1.

FIG. 11 is a diagram illustrating the prediction accuracy of the CNN model according to Example 1.

FIG. 12 is a diagram illustrating the relationship between the predicted and true values of performance data obtained by the CNN model according to Example 2, where the results are shown by sequence pattern and further broken down by performance parameters (pressure, efficiency, and flow noise).

FIG. 13 is a diagram illustrating an overview of training of a one-dimensional CNN model according to Example 3.

FIG. 14 is a diagram illustrating the relationship between the predicted values and true values of performance data obtained according to Example 3, where the results are shown by model and further broken down by performance parameters (pressure, efficiency, and flow noise).

FIG. 15 is a diagram schematically illustrating the process of comparing the prediction accuracy of performance data between a CNN model and a DNN model according to Example 4.

FIG. 16 is a diagram illustrating the prediction accuracies of the DNN model and the CNN model according to Example 4.

FIG. 17 is a diagram illustrating the processing procedure of a model training process according to a modification.

### DETAILED DESCRIPTION

A performance prediction method according to an embodiment includes a conversion process, a training process and a prediction process. The conversion process converts one-dimensional array data including a plurality of parameter values arranged in one dimension into two-dimensional array data in which the plurality of parameter values are arranged in two dimensions, by replicating and arranging all or part of the parameter values. The training process trains a machine learning model, based on training data including the two-dimensional array data and performance data corresponding to the one-dimensional array data, and generates a trained model that takes two-dimensional array data as input and provides predicted performance data as output. The prediction process applies two-dimensional array data of a processing target to the trained model to generate predicted performance data for the processing target.

The performance prediction method, program, and apparatus according to the present embodiment will be described below with reference to the accompanying drawings.

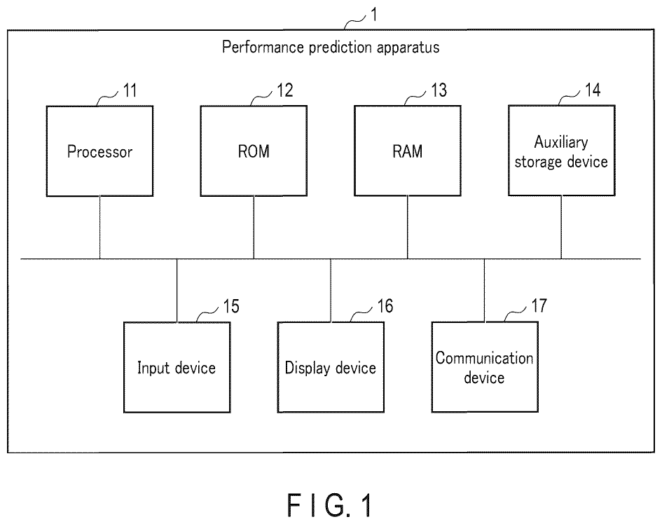

FIG. 1 is a diagram illustrating a hardware configuration of the performance prediction apparatus 1 according to the present embodiment. As shown in FIG. 1, the performance prediction apparatus 1 is a computer including a processor 11, a ROM (Read Only Memory) 12, a RAM (Random Access Memory) 13, an auxiliary storage device 14, an input device 15, a display device 16, and a communication device 17. Data and various signals are transmitted and received between the processor 11, the ROM 12, the RAM 13, the auxiliary storage device 14, the input device 15, the display device 16, and the communication device 17 via a bus.

The processor 11 is an integrated circuit that controls the overall operation of the performance prediction apparatus 1. For example, the processor 11 includes a CPU (Central Processing Unit), a GPU (Graphics Processing Unit), a DSP (Digital Signal Processor), and/or an FPU (Floating-Point Unit). The processor 11 may also include an internal memory and an I/O interface. The processor 11 executes various processes by interpreting and executing programs that are stored in advance in the ROM 12, the auxiliary storage device 14, or the like. All or part of the processor 11 may be implemented by hardware, such as an ASIC (Application Specific Integrated Circuit) or an FPGA (Field Programmable Gate Array).

The ROM 12 is a non-volatile memory that stores various data. For example, the ROM 12 stores data and setting values used by the processor 11 during the execution of various processes. The ROM 12 may include a non-transient computer-readable storage medium that stores the programs executed by the processor 11.

The RAM 13 is a volatile memory used for reading and writing data. The RAM 13 temporarily stores data used by the processor 11 during the execution of various processes. The RAM 13 provides a work area for the processor 11.

The auxiliary storage device 14 is a non-volatile memory that stores various data. For example, the auxiliary storage device 14 stores data and setting values used by the processor 11 during the execution of various processes, data generated in the processor 11 by various processes, or the like. The auxiliary storage device 14 is composed of an HDD (Hard Disk Drive), an SSD (Solid-State Drive), an integrated circuit storage device, or the like. The auxiliary storage device 14 may include a non-transient computer-readable storage medium that stores the programs executed by the processor 11.

The input device 15 takes various operation inputs from the operator. As the input device 15, a keyboard, a mouse, various switches, a touch pad, a touch panel display, or the like can be used. An electrical signal corresponding to a received operation input is supplied to the processor 11.

The display device 16 displays various data under the control of the processor 11. As the display device 16, a CRT (Cathode-Ray Tube) display, a liquid crystal display, an organic EL (Electro Luminescence) display, an LED (Light-Emitting Diode) display, a plasma display, or any other display may be used as appropriate. The output device 16 may be a projector, for example.

The communication device 17 includes a communication interface, such as a network interface card (NIC) for performing data communication with various devices connected to the performance prediction apparatus 1 via a network. It should be noted that an electrical signal may be supplied from a computer connected via the communication device 17 or an input device provided in the computer, or various data may be displayed on a display device provided in the computer connected via the communication device 17.

However, for the sake of simplicity in the following description, unless otherwise specified, it is assumed that the source of the manipulate signal is the input device 15 and that the device on which various data is displayed is the display device 16. The input device 15 can be replaced by a computer connected via the communication device 17 or an input device provided in the computer, and the display device 16 can be replaced by a display device or the like provided in the computer connected via the communication device 17.

The performance prediction apparatus 1 need not include all of the processor 11, the ROM 12, the RAM 13, the auxiliary storage device 14, the input device 15, the display device 16, and the communication device 17. As needed, some of the ROM 12, the RAM 13, the auxiliary storage device 14, the input device 15, the display device 16, and the communication device 17 may be omitted. The performance prediction apparatus 1 may be provided with any additional hardware device useful for executing the processing according to the present embodiment. The performance prediction apparatus 1 need not be physically implemented by a single computer, but may instead be configured as a computer system including a plurality of computers that are connected so as to be capable of communicating with each other via cables, network lines, or the like. The allocation of the series of processes according to the present embodiment to the plurality of processors 11 implemented in the respective computers can be determined arbitrarily. All of the processors 11 may execute the entire set of processes in parallel, or specific processes may be allocated to one or more of the processors 11, so that the series of processes according to the present embodiment are executed by the computer system as a whole.

The processor 11 executes at least a conversion process, a training process, and a prediction process. The conversion process converts one-dimensional array data including a plurality of parameter values arranged in one dimension into two-dimensional array data in which the plurality of parameter values are arranged in two dimensions, by replicating and arranging the parameter values. The one-dimensional array data is input data including a plurality of parameter values arranged in one dimension. The plurality of parameter values refer to respective values corresponding to process parameters related to a target product. Performance data includes values of one or more performance parameters used for evaluating the performance of the product.

The training process trains a machine learning model, based on training data including the two-dimensional array data and performance data corresponding to the one-dimensional array data, and generates a trained model that takes the two-dimensional array data as input and provides predicted performance data as output. The predicted performance data refers to performance data output by the trained model. The performance data and/or the predicted performance data includes parameter values of one or more performance parameters for evaluating the performance of the product.

Typically, the machine learning model is assumed to be a CNN (Convolutional Neural Network) model. The CNN model according to the present embodiment refers to a neural network model including at least a convolutional layer. The CNN model may also include other network layers such as a pooling layer and a fully connected layer. It should be noted that the training process may alternatively train a DNN (Deep Neural Network) model as the machine learning model. The DNN model according to the present embodiment refers to a neural network model that includes a fully connected layer and excludes a convolutional layer.

The prediction process generates predicted performance data of a processing target by applying two-dimensional array data of the processing target to the trained model. The two-dimensional array data of the processing target may be obtained by converting one-dimensional array data of the processing target through the conversion process.

The processing procedure of the performance prediction process executed by the processor 11 of the performance prediction apparatus 1 will be described below.

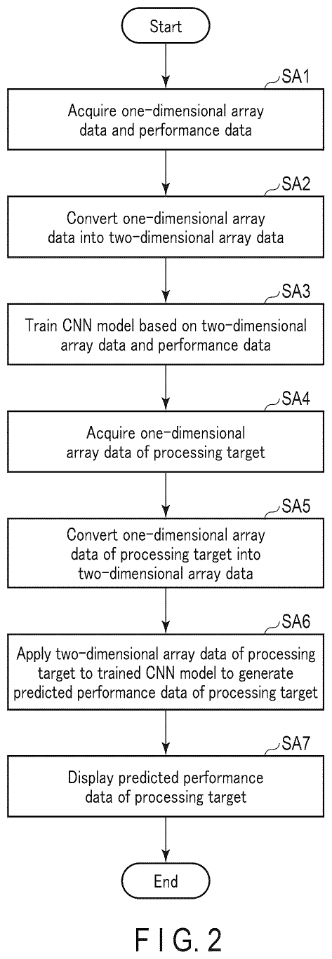

FIG. 2 is a diagram illustrating the processing procedure of the performance prediction process. The performance prediction method shown in FIG. 2 is initiated when the processor 11 reads a performance prediction program from the auxiliary storage device 14 or the like and interprets and executes the program.

First, the processor 11 acquires one-dimensional array data and performance data corresponding to the one-dimensional array data (Step SA1). A combination of the one-dimensional array data and the performance data constitutes a training sample used for training a machine learning model. In Step SA1, a plurality of training samples are acquired.

After Step SA1, the processor 11 converts the one-dimensional array data into two-dimensional array data (Step SA2). Step SA2 is performed for each of the plurality of training samples. In Step SA2, the processor 11 converts the one-dimensional array data into two-dimensional array data in which a plurality of process parameter values are arranged in two dimensions, by replicating and arranging all of the plurality of process parameter values.

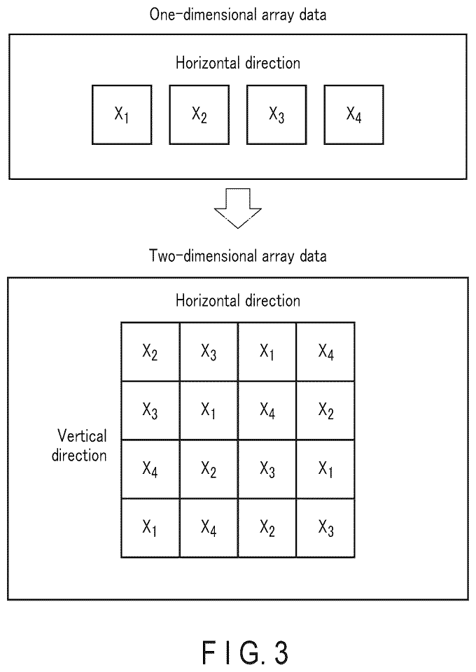

FIG. 3 is a diagram schematically illustrating the conversion from one-dimensional array parameters to two-dimensional array data. Here, each process parameter value is represented as “Xₙ.” The letter “n” is a subscript indicating the type of process parameter and satisfies 1≤n≤N. The letter “N” is the total number of types of process parameters, and “N” is a natural number equal to or greater than 2. FIG. 3 illustrates an example in which the total number of types of process parameters is 4 (N=4).

As shown in FIG. 3, the one-dimensional array parameter is N-dimensional data including N process parameter values Xn arranged in one dimension. In the present embodiment, the arrangement direction of the process parameter values Xₙ in the one-dimensional array parameter is the horizontal (row) direction. In this case, “N” means the number of elements in the horizontal direction of the one-dimensional array parameter, and the one-dimensional array data includes N process parameter values Xₙ arranged along the horizontal direction without duplication of parameter types.

The two-dimensional array data includes N×M parameter values Xₙ arranged in a two-dimensional space defined by the horizontal direction and the vertical (column) direction perpendicular to the horizontal direction. “M” denotes the number of replicates of the N process parameter values Xₙ; in other words, it represents the number of elements in the vertical direction of the two-dimensional array data. “M” is defined as a natural number equal to or greater than 2. In FIG. 3, “M” is set to 4, which is equal to “N,” and corresponds to a single column.

In Step SA2, the processor 11 may replicate the plurality of process parameter values Xₙ in the vertical direction and then rearrange them in the horizontal direction. It is preferable that the process parameter values Xₙ be arranged such that no parameter types are duplicated in the horizontal and vertical directions. For example, in the first row shown in FIG. 3, the sequence of process parameter values Xₙ is (X₂, X₃, X₁, X₄) from left to right, and this sequence does not appear in any of the second, third, or fourth rows. In another example, the sequence of the process parameter values Xₙ in the second column is (X₃, X₁, X₂, X₄) from top to bottom, and this sequence does not appear in any of the first, third, or fourth columns. By arranging the parameter types so that they are not duplicated in rows or columns, the variation of parameter type patterns within the application range (receptive field) of the filter processing performed by the convolutional layer of the CNN model (described below) can be increased, thereby ultimately enhancing the performance prediction accuracy of the CNN model. The details of the conversion process from one-dimensional array data to two-dimensional array data will be described later.

The parameter type arrangement pattern for the two-dimensional array data is common to all training samples. The parameter type arrangement pattern is stored in the auxiliary storage device 14.

After Step SA2 is executed, the processor 11 trains the CNN model, based on the two-dimensional array data and the performance data (Step SA3). First, the network configuration of the CNN model will be described.

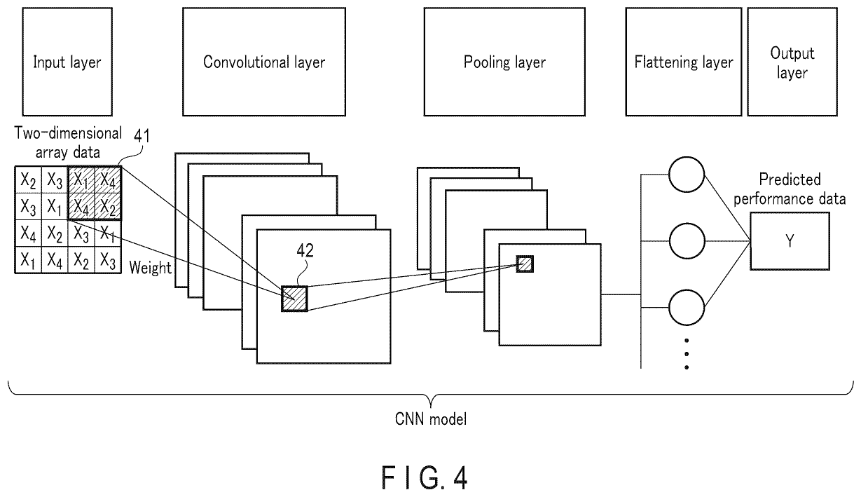

FIG. 4 is a diagram illustrating the network configuration of the CNN model. As shown in FIG. 4, the CNN model takes two-dimensional array data as input and provides predicted performance data as output. The CNN model includes an input layer, a convolutional layer, a pooling layer, a flattening layer, and an output layer.

The input layer takes the two-dimensional array data as input. The convolutional layer performs convolutional processing on its input data, using a plurality of filters, and outputs a plurality of feature maps, which are two-dimensional distributions of feature values. The number of output feature maps is equal to the number of filters. The application range 41 of each filter is also referred to as a receptive field. The convolutional layer applies each filter to the input data while shifting the application range 41 at a predetermined stride to perform convolutional operations. From the two-dimensional array of parameter values within the application range 41, the convolutional layer extracts, enhances, or suppresses local two-dimensional array patterns specific to each filter. The matrix size of the application range 41 is not limited to 2×2 but can be set to any arbitrary size. The weights at a plurality of positions within the same filter are shared.

The pooling layer performs pooling on the feature maps output from the convolutional layer while varying a pooling area 42, and applies a predetermined reduction method to the feature values within the pooling area 42 to generate a pooled map, which is a two-dimensional distribution of the reduced values. As an example, average pooling, which calculates an average value of the plurality of feature values within the pooling area 42, may be used as the reduction method. The reduction method is not limited to the average pooling; other methods, such as max pooling, which calculates the maximum value of the feature values within the pooling area 42, min pooling, which calculates the minimum value, or any other method that computes a reduction value, may also be used.

The flattening layer performs a flattening process that converts the two-dimensional pooled map into a one-dimensional array, generating one-dimensional reduced value data. The output layer performs a performance calculation process, based on the one-dimensional reduced value data, to calculate a performance value, thereby generating predicted performance data Y. The predicted performance data Y is output as a vector having parameter values of one or more performance parameters.

The network configuration of the CNN model described above is an example, and any network configuration may be used as long as convolutional processing can be performed on two-dimensional array data and predicted performance data can be output. For example, the CNN model may have a configuration in which blocks containing convolutional layers and pooling layers are coupled in series.

Additionally, a network layer for zero-padding may be provided to extend the matrix size of the feature maps or pooled maps.

In Step SA3, the processor 11 performs supervised learning based on a plurality of training samples on the CNN model to generate a trained CNN model. Specifically, the two-dimensional array data of each of the plurality of training samples is input to an untrained CNN model, and convolution processing using the convolutional layer, reduction processing using the pooling layer, flattening processing using the flattening layer, and performance calculation processing using the output layer are sequentially performed to calculate predicted performance data.

Next, the processor 11 calculates an error between the predicted performance data and the correct prediction data included in the training sample, and updates the network parameters of the CNN model based on the calculated error. The network parameters specifically include weights and biases assigned to network layers such as convolutional layers. The processor 11 repeats the processes of calculating the predicted performance data and updating the network parameters while changing the training samples, until a predetermined termination condition is satisfied. The termination condition may be set to any of various criteria, such as when the number of iterations reaches a predetermined value or when the accuracy of the predicted performance data reaches a specified value. Optimization methods such as stochastic gradient descent, Adam, or any other suitable method may be used. Training parameters such as the learning rate, batch size, and activation function can also be set arbitrarily.

In a case where the termination condition is satisfied, the network parameters at that iteration are stored in the auxiliary storage device 104 as trained network parameters. The CNN model to which the trained network parameters are assigned is used as a trained CNN model. The trained CNN model may also be stored in the auxiliary storage device 104.

Once Step SA3 is completed, the processor 11 acquires one-dimensional array data of a processing target (Step SA4). The one-dimensional array data of the processing target refers to the one-dimensional array data for which predicted performance data is to be calculated.

After Step SA4 is performed, the processor 11 converts the one-dimensional array data of the processing target into two-dimensional array data (Step SA5). In Step SA5, the processor 11 reads an arrangement pattern of parameter types from the auxiliary storage device 14 and converts the one-dimensional array data of the processing target into two-dimensional array data in accordance with the read arrangement pattern. This enables the use of a common arrangement pattern during both training and inference, thereby improving the calculation accuracy of predicted performance data. The resultant two-dimensional array data will be referred to as the two-dimensional array data of the processing target.

Once Step SA5 is completed, the processor 11 applies the two-dimensional array data of the processing target to the trained CNN model to generate predicted performance data for the processing target (Step SA6). In Step SA6, the processor 11 reads the trained CNN model from the auxiliary storage device 14, inputs the two-dimensional array data of the processing target into the read trained CNN model, and sequentially performs convolution processing using the convolutional layer, pooling processing using the pooling layer, flattening processing using the flattening layer, and performance calculation processing using the output layer, thereby calculating predicted performance data of the processing target.

Once Step SA6 is completed, the processor 11 displays the predicted performance data of the processing target on the display device 16 (Step SA7). There are no particular limitations on how the predicted performance data of the processing target is displayed. The processor 11 may display the one-dimensional array data and/or two-dimensional array data of the processing target together with the predicted performance data of the processing target. The processor 11 may also attach a label to the predicted performance data of the processing target indicating that it was generated by the CNN model, and may display it accordingly.

In the manner described above, the performance prediction process by the processor 11 is completed.

Next, a detailed description will be given of the processing performed by the processor 11 to convert one-dimensional array data into two-dimensional array data. In this conversion process, a sequence of M arrays is sequentially generated by arranging N parameter values, in an order based on a predetermined algorithm, into each of M columns defined in a two-dimensional space along a first direction and a second direction. Here, in order to ensure that parameter types are not duplicated in a predetermined direction other than the first direction (hereinafter referred to as the “check direction”) between adjacent first and second arrays, the parameter values of the first or the second array are rearranged, thereby generating two-dimensional array data.

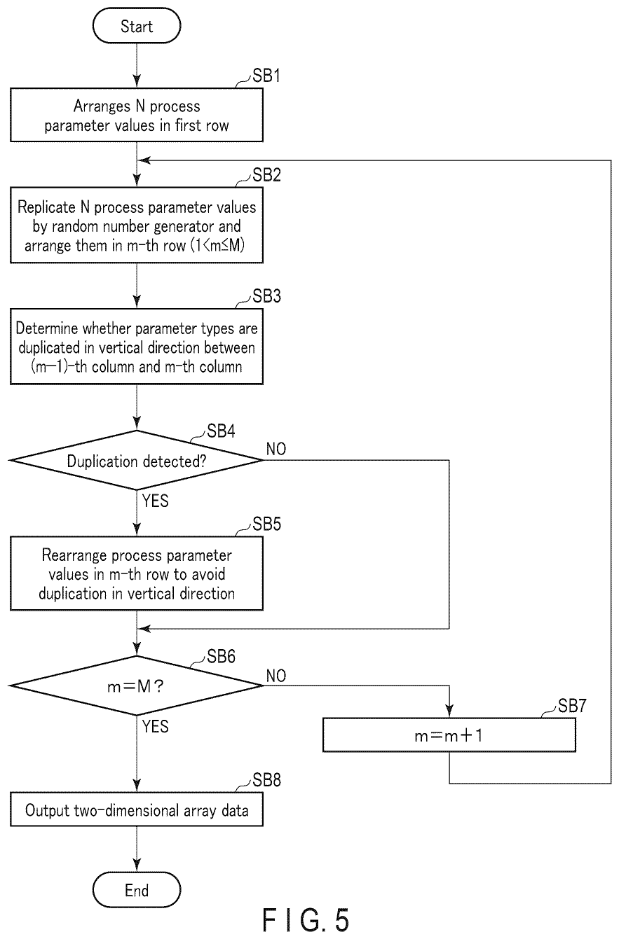

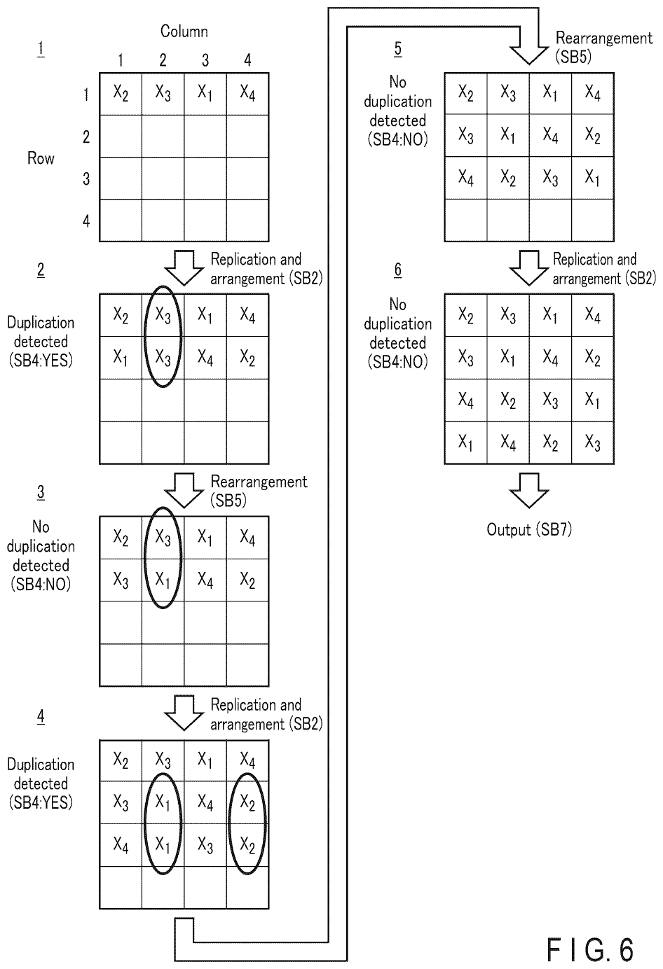

FIG. 5 is a diagram illustrating the processing procedure for conversion from one-dimensional array data into two-dimensional array data. FIG. 6 is a diagram schematically illustrating a specific example of the processing procedure shown in FIG. 5. In FIGS. 5 and 6, the first direction is the horizontal direction, the second direction is the vertical direction, and the check direction is the vertical direction. In FIG. 6, the total number N of parameter types is 4, and the total number M of columns is also 4. That is, the two-dimensional space defined by the first and second directions consists of 4×4 pixels.

As shown in FIG. 5, the processor 11 arranges N process parameter values Xₙ of the one-dimensional array data in the first row (Step SB1). The order of the process parameter values Xₙ in the first row may be an arbitrary order, such as the original order. For example, as shown in portion 1 of FIG. 6, the N process parameter values Xₙ are arranged in the first row from column 1 to column 4 in the order (X₂, X₃, X₁, X₄).

After Step SB1 is executed, the processor 11 causes a random number generator to replicate the N process parameter values Xₙ and arranges them in the m-th row (Step SB2). The value m is sequentially set from 2 to M. Initially, m=2 is set. In the case of m=2, the processor 11 causes the random number generator to generate a process parameter value Xₙ corresponding to one of the four parameter types, and arranges the generated value Xₙ in the empty pixel of the first column of the second row. Next, the processor 11 causes the random number generator to generate another process parameter value Xₙ corresponding to one of the remaining three parameter types, and arranges the generated value Xₙ in the empty pixel of the second column of the second row. Similarly, the processor 11 arranges the process parameter values Xₙ in the empty pixels of the third and fourth columns of the second row. As a result, the process parameter values Xₙ are arranged in the second row in a sequence determined by the random number generator. Consequently, as shown in portion 2 of FIG. 6, it is assumed that the N process parameter values Xₙ are arranged in the second row in the order (X₁, X₃, X₄, X₂).

After Step SB2 is executed, the processor 11 determines whether parameter types are duplicated in the vertical direction (check direction) between the (m−1)-th column and the m-th column (Step SB3). The presence or absence of duplication is determined for all columns. For example, as shown in portion 2 of FIG. 6, in the second column, the parameter types of the first and second rows are both X3. Therefore, duplication is detected. On the other hand, in the other columns (columns 1, 3, and 4), the parameter types differ between the first and second rows, and thus no duplication is detected.

If duplication is detected in at least one column (Step SB4: YES), the processor 11 rearranges the process parameter values Xₙ in the m-th row to avoid duplication in the vertical direction (Step SB5). The method of rearrangement is not particularly limited. For example, the processor 11 may rearrange the N process parameter values Xn in the second row according to a newly generated random order using the random number generator; alternatively, the processor 11 may replace the process parameter value Xn included in a duplicated pixel with a process parameter value included in another pixel adjacent in the horizontal direction. As shown in portion 3 of FIG. 6, the duplication in parameter types in the vertical direction can be avoided by exchanging the process parameter values Xn between the pixels in the first and second columns of the second row.

In a case where Step SB5 is executed or if no duplication is detected (Step SB4: NO), the processor 11 determines whether the m-th row of the processing target is the final M-th row, that is, whether m=M (Step SB6). If it is determined that m is not M (Step SB6: NO), the processor 11 shifts the m-th row of the processing target downward by one, i.e., performs m=m+1 (Step SB7). The processor 11 repeats Steps SB2 to SB6 for the m-th row of the processing target until it is determined in Step SB6 that the m-th row of the processing target is the final M-th row. Through this process, the two-dimensional array data is output.

For example, as shown in portion 4 of FIG. 6, the processor 11 causes the random number generator to replicate the N process parameter values Xₙ and arranges them in the third row, and then determines whether parameter types are duplicated in the vertical direction in Step SB3 (Step SB2). In the case of portion 4 of FIG. 6, since duplication is detected in the second and fourth columns (Step SB4: YES), the processor 11 rearranges the N process parameter values Xₙ in the third row, as shown in portion 5 of FIG. 6 (Step SB5). Next, as shown in portion 6 of FIG. 6, the processor 11 causes the random number generator to replicate the N process parameter values Xₙ and arranges them in the final fourth row (Step SB2). In the case of portion 6 of FIG. 6, it is determined that no duplication exists in the vertical direction with respect to all columns (Step SB4: NO).

In a case where it is determined that that the m-th row of the processing target is the final M-th row (Step SB6: YES), the processor 11 outputs the two-dimensional array data (Step SB8).

In the manner described above, the conversion process from one-dimensional array data to two-dimensional array data is completed.

By arranging N parameter values Xₙ in a two-dimensional space according to the above algorithm, two-dimensional array data can be generated in which no parameter types are duplicated in either the horizontal or vertical direction. By avoiding duplication of parameter types in both the horizontal and vertical directions, the diversity in the arrangement of parameter values Xₙ within the receptive field 41 of the convolutional processing can be increased, which in turn improves the prediction accuracy of performance data.

It should be noted that the conversion process mentioned above is merely an example, and various modifications such as deletion, addition, and/or changes of the steps are available. As an example, the initial row for arranging the N parameter values Xₙ is not limited to the first row but may be any row such as the M-th row. As another example, while the N parameter values Xₙ were assumed to be arranged along rows, they may alternatively be arranged along columns.

From another point of view, in the above conversion process, the direction for checking duplication of parameter types was described as the vertical direction, but it may instead be a diagonal direction. Moreover, the checking direction is not limited to a single direction, and two directions such as the vertical and diagonal directions may be used. The range for determining duplication of parameter types (hereinafter referred to as the “duplication determination range”) is not limited to two adjacent pixels in the checking direction, as described above, but may be set to an arbitrary rectangular region composed of a number of pixels equal to or less than the number of parameter types. In this case, the processor 11 arranges a plurality of parameter values such that the arrangement pattern of parameter types within the predetermined rectangular region is not duplicated at any position in the two-dimensional array data. For example, in a case where N=4, a square region of (2 vertical pixels×2 horizontal pixels) may be set as a duplication determination range. In this case, since duplication of parameter types can be avoided within the duplication determination range, diagonal duplication can also be avoided, which was permitted in the algorithms of FIGS. 5 and 6 that avoided only vertical duplication.

Next, Examples relating to the present embodiment will be described.

### Example 1

Example 1 compares the prediction accuracy of performance data between a CNN model and a DNN model.

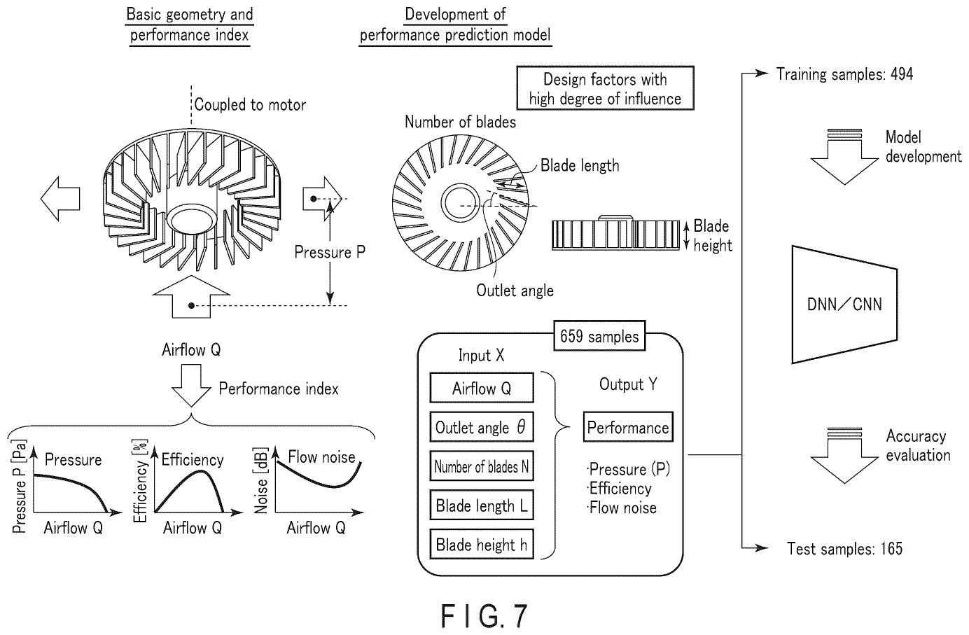

FIG. 7 is a diagram schematically illustrating the processing procedure for comparing the prediction accuracy of performance data between the CNN model and the DNN model. The product of Example 1 is a centrifugal blower. As shown in FIG. 7, the process parameters include five types: airflow Q, outlet angle θ, number of blades N, blade length L, and blade height h. The performance parameters include three types: pressure, efficiency, and flow noise. Each of the three performance parameter values is derived based on the five process parameter values.

A total of 659 samples were prepared, each of which was a combination of process parameter values and performance parameter values. Of these, 454 samples were used as training samples, and the remaining 165 samples were used as test samples. The DNN model and CNN model were trained using the training samples, and their prediction accuracies were evaluated using the test samples.

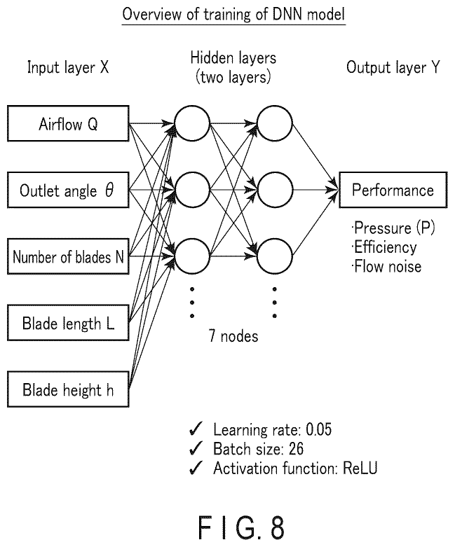

FIG. 8 is a diagram illustrating an overview of the training of the DNN model used in Example 1. As shown in FIG. 8, the DNN model includes two hidden layers. Each hidden layer is a fully connected layer with seven nodes. Weights, which are network parameters, are assigned to the connections between the nodes. The DNN model was trained through supervised learning based on 454 training samples. In each sample, five process parameter values X (airflow Q, outlet angle θ, number of blades N, blade length L, and blade height h) were used as inputs, and three performance parameter values Y (pressure, efficiency, and flow noise) were used as outputs. The learning rate was set to 0.05, the batch size was 26, and ReLU was used as the activation function for the hidden layers.

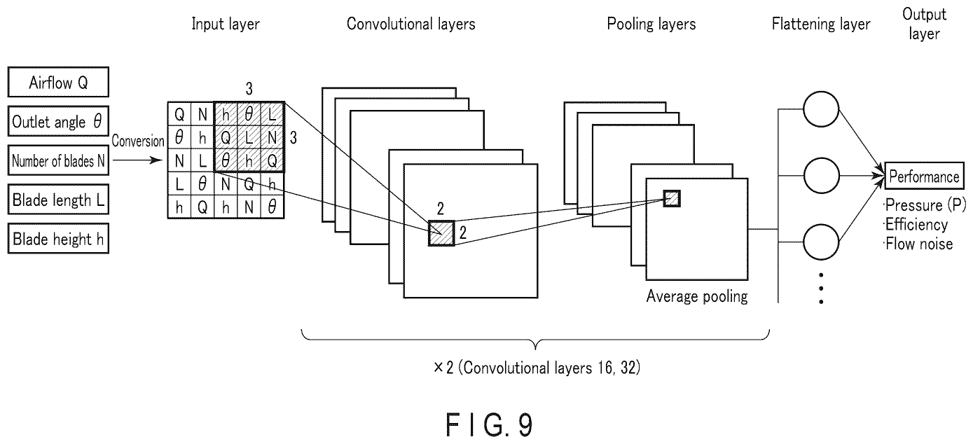

FIG. 9 is a diagram illustrating an overview of the training process for the CNN model according to Example 1. As shown in FIG. 9, the CNN model includes convolutional layers and pooling layers. Two blocks, each of which is a combination of convolutional and pooling layers, are coupled. The number of filters in the convolutional layers is 16 for the first block and is 32 for the second block. The matrix size of the receptive field in the convolutional layers is 3×3, and the matrix size of the pooling area in the pooling layers is 2×2. The CNN model was trained through supervised learning based on the 454 training samples, and in each sample, five process parameter values X (airflow Q, outlet angle θ, number of blades N, blade length L, and blade height h) were used as inputs, and three performance parameter values Y (pressure, efficiency, and flow noise) were used as outputs. The input two-dimensional array data has an array pattern (random arrangement) with no parameter types duplicated in either the vertical or horizontal direction. The random arrangement allows duplication in part of the diagonal direction. The learning rate was set to 0.05, the batch size was set to 26, and ReLU was used as the activation function.

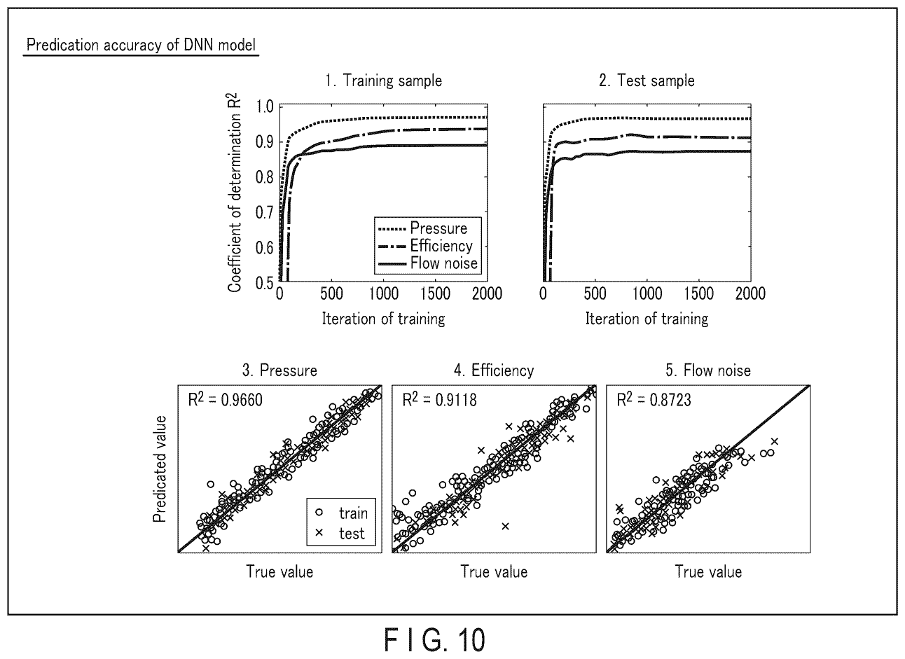

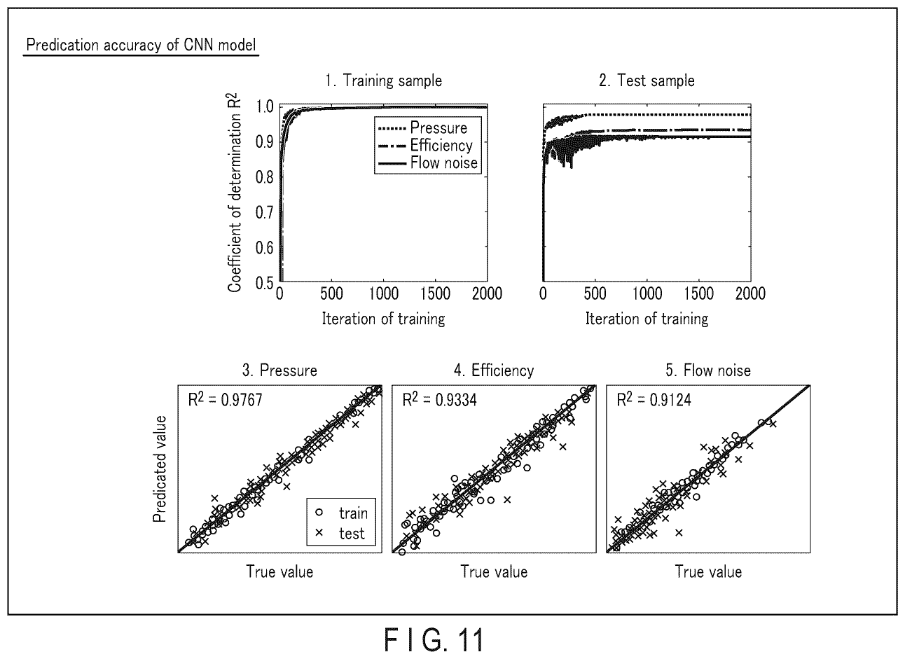

FIG. 10 is a diagram illustrating the prediction accuracy of the DNN model. FIG. 11 is a diagram illustrating the prediction accuracy of the CNN model. In both FIG. 10 and FIG. 11, Graphs 1 show the coefficient of determination R² for each performance parameter type at each iteration of training using the training samples, and Graphs 2 show the coefficient of determination R² for each performance parameter type at each iteration of training using the test samples. Graphs 3 in FIGS. 10 and 11 show the relationship between the predicted and true values for the performance parameter value of pressure. Graphs 4 in FIGS. 10 and 11 show the relationship between the predicted and true values for the performance parameter value of efficiency. Graphs 5 in FIGS. 10 and 11 show the relationship between the predicted and true values for the performance parameter value of flow noise. The true values refer to the correct prediction data in the sample.

As can be seen from the comparison of FIG. 10 and FIG. 11, in both the training and test samples, the CNN model achieves a better coefficient of determination R² for all performance parameters, compared to the DNN model. In particular, the coefficient of determination R² for flow noise is 0.8723 in the DNN model, whereas it is 0.9124 in the CNN model, indicating a significant degree of improvement.

### Example 2

In Example 2, the dependency of the array pattern of parameter types in the two-dimensional array data on the prediction accuracy of the CNN model is evaluated. The product, process parameters, and performance parameters used in Example 2 are similar to those in Example 1.

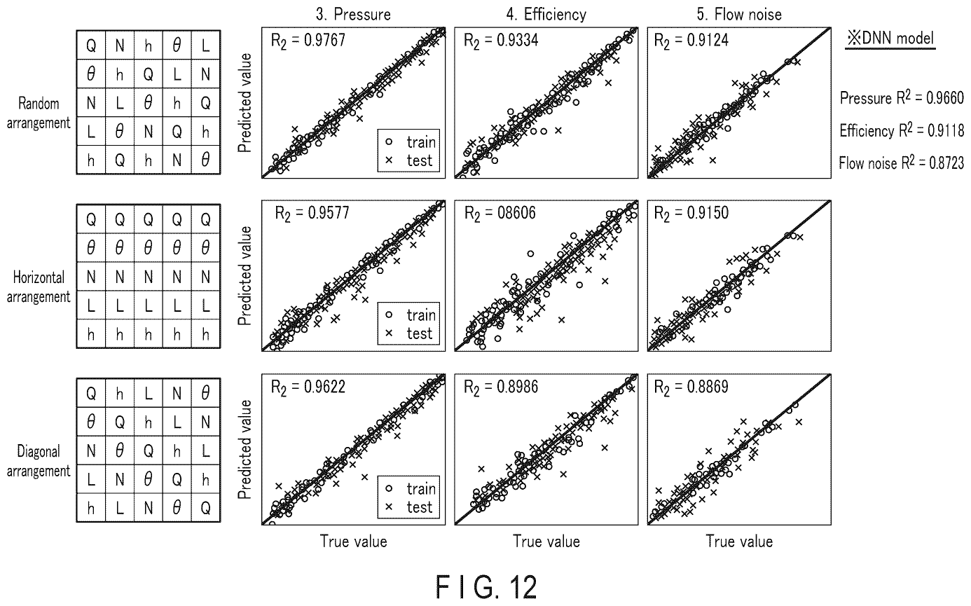

FIG. 12 shows the relationship between the predicted and true values of the performance data obtained by the CNN model, where the results are shown by sequence pattern and further broken down by performance parameters (pressure, efficiency, and flow noise). The arrangement pattern in the upper portion of FIG. 12 is a random arrangement pattern. The random arrangement is a pattern in which no parameter types are duplicated in either the vertical or horizontal direction, and parameter types are duplicated only in part of the diagonal direction. The arrangement pattern in the middle portion of FIG. 12 is a horizontal arrangement pattern. In the horizontal arrangement pattern, no parameter types are duplicated in either the vertical or diagonal direction, and parameter types are duplicated in the horizontal direction. The arrangement pattern in the lower portion of FIG. 12 is a diagonal arrangement pattern. In the diagonal arrangement pattern, no parameter types are duplicated in either the horizontal or vertical direction, and parameter types are duplicated in all diagonal directions.

Compared to the performance parameter values predicted by the DNN model shown in FIG. 12, the prediction accuracy for flow noise is improved in all arrangement patterns. With respect to the random arrangement, the prediction accuracy is improved for all performance parameters (i.e., pressure, efficiency and flow noise), compared to the DNN model. In particular, a significant improvement in prediction accuracy is observed for efficiency. Therefore, it can be concluded that the random arrangement pattern yields higher prediction accuracy than the horizontal and diagonal arrangement patterns.

### Example 3

In Example 3, the difference in prediction accuracy between one-dimensional array data and two-dimensional array data is evaluated with respect to a CNN model. The product, process parameters, and performance parameters used in Example 3 are similar to those in Example 1.

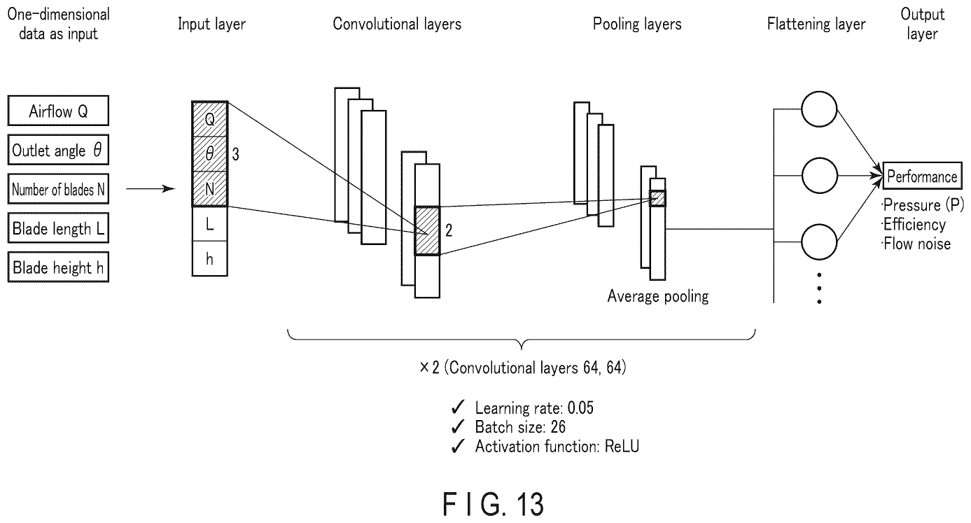

FIG. 13 is a diagram schematically illustrating an overview of the training process for the one-dimensional CNN model according to Example 3. As shown in FIG. 13, the one-dimensional CNN model includes an input layer, convolutional layers, pooling layers, a flattening layer, and an output layer, similarly to the two-dimensional CNN model shown in FIG. 9. The input layer takes one-dimensional array data in which the five process parameter values X (airflow Q, outlet angle θ, number of blades N, blade length L, and blade height h) are arranged in one dimension. The convolutional layers perform one-dimensional convolution operations. The receptive field of each convolutional layer has a matrix size of 3. The pooling layers perform one-dimensional pooling operations, and the pooling area of each pooling layer has a matrix size of 2. Two blocks, each of which is a combination of convolutional and pooling layers, are coupled in series. The number of filters in the convolutional layers is 64 for each of the first block and the second block. The one-dimensional CNN model was trained through supervised learning based on 454 training samples. In each sample, the five process parameter values X (airflow Q, outlet angle θ, number of blades N, blade length L, and blade height h) arranged in one dimension were used as inputs, and the three performance parameter values Y (pressure, efficiency, and flow noise) were used as outputs. The learning rate was set to 0.05, the batch size was set to 26, and ReLU was used as the activation function.

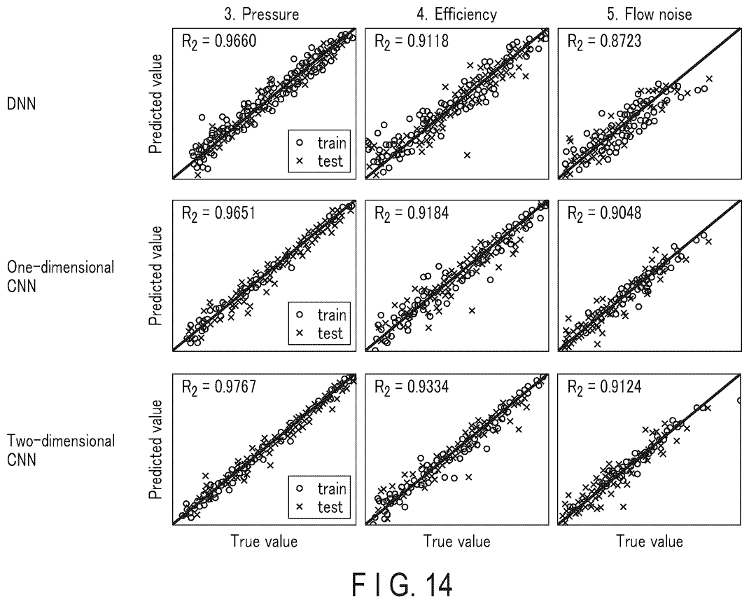

FIG. 14 is a diagram illustrating the relationship between the predicted values and true values of performance data, where the results are shown by model and further broken down by performance parameters (pressure, efficiency, and flow noise). The model in the upper portion of FIG. 14 corresponds to the DNN model shown in FIG. 8, the model in the middle portion of FIG. 14 corresponds to the one-dimensional CNN model shown in FIG. 13, and the model in the lower portion of FIG. 14 corresponds to the two-dimensional CNN model shown in FIG. 9. A comparison between the upper and middle portions of FIG. 14 shows that the one-dimensional CNN model achieves improved prediction accuracy only for flow noise, compared to the DNN model. A comparison between the middle and lower portions of FIG. 14 shows that the two-dimensional CNN model improves prediction accuracy for all performance parameters (pressure, efficiency, and flow noise), compared to the one-dimensional CNN model. This may be attributed to the fact that the one-dimensional model takes one-dimensional array data as input, whereas the two-dimensional model takes two-dimensional array data as input, thereby enabling the two-dimensional model to extract a wider variety of local arrangement patterns of process parameter types compared to the one-dimensional model.

### Example 4

In Example 4, the prediction accuracies of the DNN and CNN models were evaluated using a product, process parameters, and a performance parameter that were different from those used in Examples 1, 2, and 3.

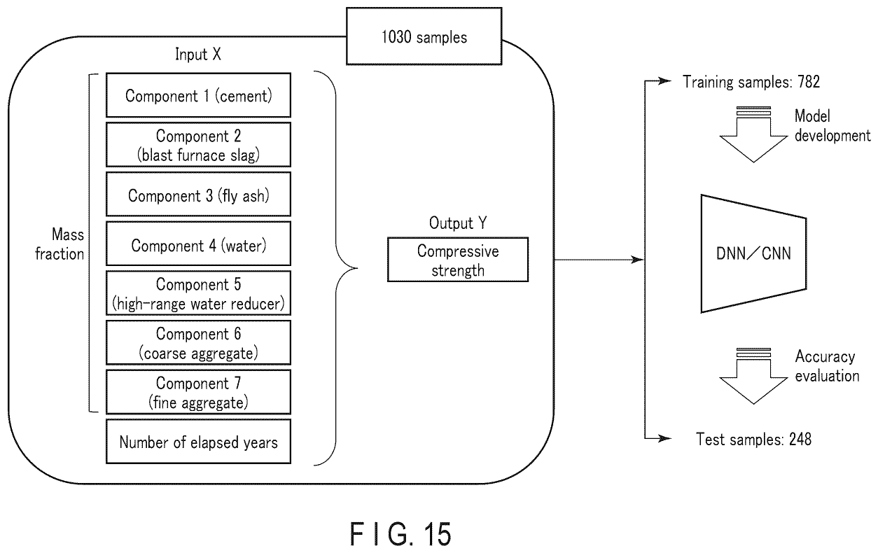

FIG. 15 is a diagram schematically illustrating the process of comparing the prediction accuracy of performance data between the CNN model and the DNN model according to Example 4. The product in Example 4 is “concrete.” As shown in FIG. 15, the process parameters consist of eight types: the mass fraction of Component 1 (cement), the mass fraction of Component 2 (blast furnace slag), the mass fraction of Component 3 (fly ash), the mass fraction of Component 4 (water), the mass fraction of Component 5 (high-range water reducer), the mass fraction of Component 6 (coarse aggregate), the mass fraction of Component 7 (fine aggregate), and the number of elapsed years. The performance parameter is a single type: compressive strength. Based on the values of the eight process parameters, the value of one performance parameter is derived.

A total of 1030 samples were prepared, each of which was a combination of the process parameter values and the performance parameter value. Of these, 782 samples were used as training samples, and the remaining 248 samples were used as test samples. The DNN model and CNN model were trained using the training samples, and their prediction accuracies were evaluated using the test samples.

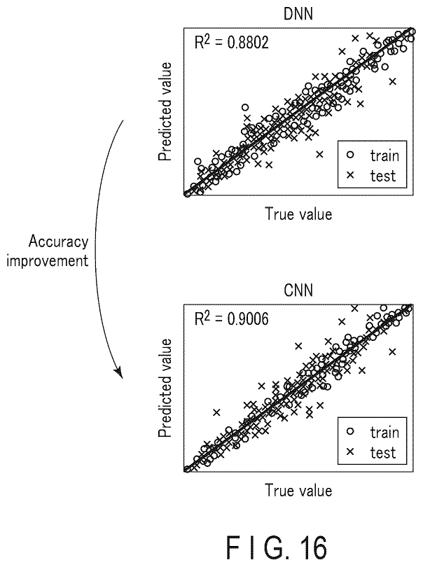

FIG. 16 is a diagram illustrating the prediction accuracies of the DNN and CNN models according to Example 4. The upper portion of FIG. 16 is a graph illustrating the relationship between the predicted and actual values of compressive strength, which is the performance parameter for the DNN model, while the lower portion of FIG. 16 is a graph illustrating the same relationship for the CNN model. As shown in FIG. 16, the coefficient of determination R² for the DNN model is 0.8802, while that for the CNN model is 0.9006. This indicates that the CNN model also achieves higher prediction accuracy than the DNN model for the process and performance parameters used in Example 4.

### Modification

In the training process according to a modification, a first trained model including fully connected layers and excluding convolutional layers is generated. If the performance of the first trained model does not satisfy a predetermined criterion, a second trained model including convolutional layers is generated as an alternative. The model training process according to the modification will be described in detail below. The first trained model refers to a DNN model, and the second trained model refers to a CNN model.

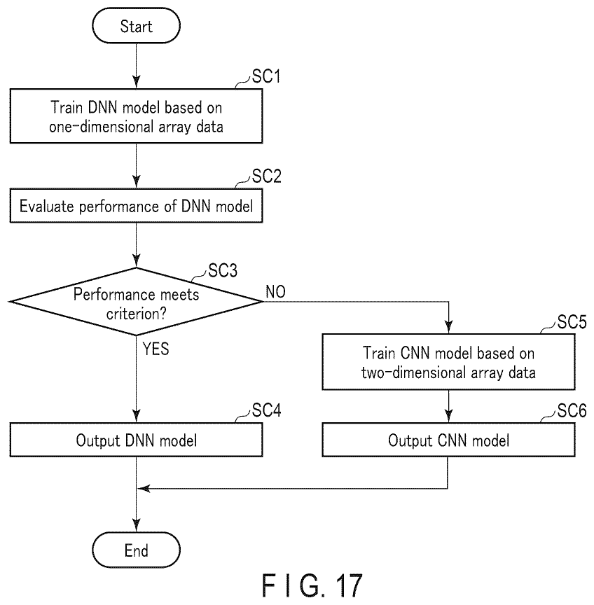

FIG. 17 is a diagram illustrating the processing procedure of the model training process according to the modification. As shown in FIG. 17, the processor 11 first trains the DNN model, based on one-dimensional array data, to generate a trained DNN model (Step SC1). As described above, the DNN model can be trained through supervised learning based on training samples.

Once Step SC1 is completed, the processor 11 evaluates the performance of the trained DNN model (Step SC2). Specifically, the processor 11 applies samples to the trained DNN model and calculates parameter values used to evaluate the performance of the trained DNN model. Any indicator, such as the coefficient of determination R² or accuracy, can be used as one of the parameter value.

After Step SC2, the processor 11 determines whether the performance meets the predetermined criterion (Step SC3). Specifically, the processor 11 determines whether the parameter value for performance evaluation, calculated in Step SC2, exceeds a reference value. If the parameter value exceeds the reference value, it is determined that the performance meets the criterion. Conversely, if the parameter value is below the reference value, it is determined that the performance does not meet the criterion.

In a case where it is determined in Step SC3 that the performance meets the criterion (Step SC3: YES), the processor 11 outputs the trained DNN model (Step SC4). The output trained DNN model is then used to generate predicted performance data.

On the other hand, in a case where it is determined in Step SC3 that the performance does not meet the criterion (Step SC3: NO), the processor 11 trains the CNN model, based on two-dimensional array data, to generate a trained CNN model (Step SC5). The CNN model may be trained through supervised learning based on training samples, in the same manner as described above.

Once Step SC5 is completed, the processor 11 outputs the trained CNN model (Step SC6). The output trained CNN model is then used to generate predicted performance data. Optionally, the trained DNN model may also be output along with the trained CNN model.

Once Step SC4 or SC6 is completed, the model training process according to the modification ends.

As described above, since the DNN model takes one-dimensional array data as input and the CNN model takes two-dimensional array data, the training load of the DNN model is expected to be lighter than that of the CNN model. Moreover, the performance of the DNN and CNN models can vary depending on the types of process parameters and performance parameters. According to the modification, the DNN model is trained first, and only when its performance does not meet the criterion is the CNN model trained. In a case where the performance of the DNN model meets the required criterion, a machine learning model with high accuracy can be obtained with a low computational load. Furthermore, an appropriate machine learning model can be generated in accordance with the types of process parameters and performance parameters.

As described above, according to the above embodiment, it is possible to provide a performance prediction method, storage medium, and apparatus that improve the accuracy of performance prediction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A performance prediction method comprising:
a conversion process of converting one-dimensional array data including a plurality of parameter values arranged in one dimension into two-dimensional array data in which the plurality of parameter values are arranged in two dimensions, by replicating and arranging the plurality of parameter values;
a training process of training a machine learning model, based on training data including the two-dimensional array data and performance data corresponding to the one-dimensional array data, and generating a trained model that takes the two-dimensional array data as input and provides predicted performance data as output; and
a prediction process of applying two-dimensional array data of a processing target to the trained model to generate predicted performance data for the processing target.

2. The performance prediction method according to claim 1, wherein the conversion process includes arranging the plurality of parameter values such that parameter types are not duplicated in each column or each row of the two-dimensional array data.

3. The performance prediction method according to claim 1, wherein the conversion process includes arranging the plurality of parameter values such that an arrangement pattern of parameter types within a rectangular region of a predetermined size is not duplicated at any position in the two-dimensional array data.

4. The performance prediction method according to claim 1, wherein the one-dimensional array data includes N parameter values (N: a natural number) arranged in one dimension as the plurality of parameter values;
the two-dimensional array data includes N×M parameter values (M: a natural number) arranged in a two-dimensional space defined by a first direction and a second direction perpendicular to the first direction; and
the conversion process includes sequentially generating M arrays by arranging the N parameter values in each of M columns in the two-dimensional space according to an order based on a predetermined algorithm, wherein the two-dimensional array data is generated by rearranging the parameter values of either of adjacent first and second arrays such that parameter types are not duplicated in a predetermined direction other than the first direction between the adjacent first and second arrays.

5. The performance prediction method according to claim 1, wherein the machine learning model is a convolutional neural network that includes a convolutional layer which performs convolutional processing on the two-dimensional array data, using a plurality of filters.

6. The performance prediction method according to claim 1, wherein the training process includes:
generating as the trained model a first trained model that includes a fully connected layer and not includes a convolutional layer; and
generating as the trained model a second trained model that includes the convolutional layer, in a case where performance of the first trained model does not meets a criterion.

7. The performance prediction method according to claim 1, wherein the plurality of parameter values include a plurality of values respectively corresponding to a plurality of process parameters related to a product, and
the performance data and/or the predicted performance data includes values of one or more performance parameters for evaluating performance of the product.

8. The performance prediction method according to claim 7, wherein the plurality of process parameters include at least two types selected from among airflow, outlet angle, number of blades, blade length, and blade height in a centrifugal blower used as the product, and
the one or more performance parameters include pressure, efficiency, and/or flow noise.

9. A non-transitory computer-readable storage medium including computer executable instructions, wherein the instructions, when executed by a processor, cause the processor to perform operations comprising:
a conversion process of converting one-dimensional array data including a plurality of parameter values arranged in one dimension into two-dimensional array data in which the plurality of parameter values are arranged in two dimensions, by replicating and arranging the plurality of parameter values;
a training process of training a machine learning model, based on training data including the two-dimensional array data and performance data corresponding to the one-dimensional array data, and generating a trained model that takes the two-dimensional array data as input and provides predicted performance data as output; and
a prediction process of applying two-dimensional array data of a processing target to the trained model to generate predicted performance data for the processing target.

10. A performance prediction apparatus comprising a processor, wherein the processor is configured to:
convert one-dimensional array data including a plurality of parameter values arranged in one dimension into two-dimensional array data in which the plurality of parameter values are arranged in two dimensions, by replicating and arranging the plurality of parameter values;
train a machine learning model, based on training data including the two-dimensional array data and performance data corresponding to the one-dimensional array data, and generate a trained model that takes the two-dimensional array data as input and provides predicted performance data as output; and
apply two-dimensional array data of a processing target to the trained model to generate predicted performance data for the processing target.
